(19) United States
(12) Patent Application Publication
(10) Pub. No.: US 2017/0251640 A1
(43) Pub. Date: Sep. 7, 2017

(54) ANIMAL COLLARS INCLUDING ADJUSTABLE CLAMPS AND QUICK RELEASE FEATURES

(71) Applicant: NakedMutt, LLC, Godfrey, IL (US)

(72) Inventor: Michele Eastman, Godfrey, IL (US)

(21) Appl. No.: 15/450,993

(22) Filed: Mar. 6, 2017

Related U.S. Application Data
(60) Provisional application No. 62/304,908, filed on Mar. 7, 2016.

(51) Int. Cl. A01K 27/00; F16G 11/04

(52) U.S. Cl. CPC A01K 27/005; A01K 27/006; A01K 27/001; F16G 11/04

(57) ABSTRACT

An animal collar includes a cord having a first end and a second end, a first clamp coupled to the cord, and a second clamp coupled to the cord. Each of the first and second clamps defines a first passage and a second passage. The cord extends from the first end, through the first and second passages in each of the first and second clamps, and to the second end to define a closed loop. The first clamp and the second clamp are adjustably coupled to the cord such that a size of the loop is selectively adjustable.

### CROSS-REFERENCE TO RELATED APPLICATIONS

This application claims priority to U.S. Provisional Patent Application No. 62/304,908, filed Mar. 7, 2016, the disclosure of which is hereby incorporated by reference in its entirety.

### BACKGROUND

The subject matter disclosed herein relates generally to animal collars and, more particularly, to an animal collar with features that facilitate quickly and easily adjusting, placing, and removing the collar.

At least some known animal collars are used to restrain animals during walking and transport by including at least a portion of the collar that encircles the neck of the animal. Some known animal collars include at least one feature to allow adjustment of the collar to better fit the animal as it grows or to allow the collar to be used on different-sized animals. For example, but not by way of limitation, at least some known animal collars allow for the collar to be adjusted by pulling the main collar strap through a buckle device. The safety of at least some such collars is reduced at least in part by the slack portion of the collar that is left after the collar is tightened and the lack of a rapid removal provision in the collar.

Moreover, it is common to remove collars from animals when the animals are at a commercial environment or animal care facility, such as boarding facilities, shelters, animal hospitals, clinics, zoos, and livestock lots, to prevent entanglement issues and negative interactions with other animals at the facility. However, it is still desirable to have a means to identify the animal. Some facilitates use disposable animal collars as a means to identify the animal while at such facilities. However, it can be costly to continuously replace such disposable collars for animals. Moreover, at least some known disposable collars can be unintentionally removed by the animal, thereby eliminating the animal-identification means.

### BRIEF DESCRIPTION

In one aspect, an animal collar is provided. The animal collar includes an elastic cord having a first end and a second end, a first clamp coupled to the cord, and a second clamp coupled to the cord. Each of the first and second clamps defines a first passage and a second passage. The cord extends from the first end, through the first and second passages in each of the first and second clamps, and to the second end to define a closed loop. The first clamp and the second clamp are adjustably coupled to the cord such that a size of the loop is selectively adjustable.

In another aspect, an animal collar is provided. The animal collar includes at least one cord having a first end and a second end, a first clamp coupled to the at least one cord, and a second clamp coupled to the at least one cord. Each of the first and second clamps defines a first passage and a second passage. The at least one cord extends from the first end, through the first and second passages in each of the first and second clamps, and to the second end to define a closed loop. The first clamp and the second clamp are adjustably coupled to the at least one cord such that a size of the loop is selectively adjustable.

In yet another aspect, an animal collar is provided. The animal collar includes a first cord, a second cord, a first clamp coupled to the first cord and the second cord, and a second clamp coupled to the first cord and the second cord. Each of the first and second clamps defines a first passage and a second passage. The first cord extends from a first end through the first passage in each of the first and second clamps to a second end, and the second cord extends from a first end through the second passage in each of the first and second clamps to a second end. The animal collar also includes a quick-release assembly including a first coupler coupled to the second end of the first cord, and a second coupler coupled to the second end of the second cord. The first coupler is releasably coupleable to the second coupler to define a closed loop with the first and second cords. The first clamp and the second clamp are adjustably coupled to the first and second cords such that a size of the loop is selectively adjustable.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an exemplary animal collar;

FIG. 2 is a perspective view of an exemplary clamp that may be used with the animal collar shown in FIG. 1;

FIG. 3 is a perspective view of the animal collar shown in FIG. 1, illustrating a method of assembling the animal collar;

FIG. 4 is partial perspective view of the collar shown in FIG. 1, illustrating a step in the method of assembling the animal collar;

FIG. 5 is a partial perspective view of the animal collar shown in FIG. 1, illustrating another step in the method of assembling the animal collar;

FIG. 6 is a partial perspective view of the animal collar shown in FIG. 1, illustrating another step in the method of assembling the animal collar;

FIG. 7 is a partial perspective view of the animal collar shown in FIG. 1, illustrating an exemplary identification tag connected to the animal collar by an attachment device;

FIG. 8 is a perspective view of another embodiment of an animal collar including a plurality of cord segments and a quick-release assembly;

FIG. 9 is a perspective view of another embodiment of an animal collar including a single cord segment and quick-release assembly.

### DETAILED DESCRIPTION

The embodiments described herein relate to animal collars that includes adjustable features and rapid removal features. In some embodiments, the animal collar includes a single, continuous elastic cord and two adjustment clamps that facilitate selectively sizing the collar to fit multiple animals while reducing or eliminating excess or loose-hanging portions of the collar to facilitate minimizing entanglement of the collar risk. Additionally or alternatively, the flexible cord is further configured to facilitate releasing from the animal if the collar becomes entangled with foreign objects by stretching to a size that permits removal of the collar over the animal's head. In certain embodiments, the animal collar includes a quick release assembly including couplers, two elastic cords, and two adjustment clamps that facilitate sizing the collar to fit multiple animals without leaving loose-hanging portions of the collar. Additionally or alternatively, the couplers are further configured to couple around an animal's neck and to decouple when exposed to certain amount of tensile force to facilitate removal of the collar by a user or detachment of the collar if the animal becomes entangled. In certain embodiments, the animal collar includes a quick-release assembly and a single elastic cord including two adjustment clamps that facilitate sizing the collar to fit multiple animals without leaving loose-hanging portions of the collar.

In the following specification and the claims, reference will be made to a number of terms, which shall be defined to have the following meanings.

The singular forms “a”, “an”, and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

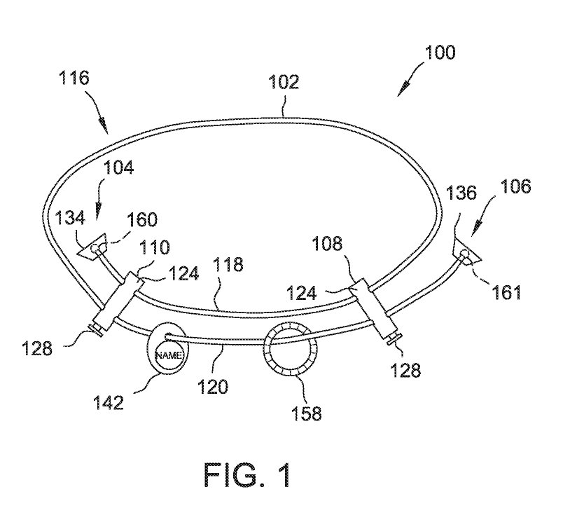

FIG. 1 is a perspective view of an exemplary animal collar 100. In the exemplary embodiment, animal collar 100 is a dog collar. In alternative embodiments, animal collar 100 is configured for use with animals other than dogs, such as other pets (e.g., cats) and non-domesticated animals (e.g. livestock and zoo-kept animals). In the exemplary embodiment, animal collar 100 includes a cord 102, a first clamp 108, a second clamp 110, a first concealing member 134, a second concealing member 136, an identification tag 142, and an attachment device 158. It is understood that in some other suitable embodiments, animal collar 100 may include any combination(s) of cord 102, first clamp 108, second clamp 110, first concealing member 134, second concealing member 136, identification tag 142, and attachment device 158. In some embodiments, for example, identification tag 142 is coupled to cord 102 via attachment device 158 (see FIG. 7). In other embodiments, such as the embodiment shown in FIG. 1, identification tag 142 is coupled directly to cord 102. In such embodiments, attachment device 158 may be omitted from collar 100. It is further contemplated that animal collar 100 can include first clamp 108 and second clamp 110 that are substantially similar in structure without departing from some aspects of this disclosure.

As illustrated in FIG. 1, cord 102 of animal collar 100 includes a first end 104 and a second end 106. In the illustrated embodiment, cord 102 has a length measured from first end 104 to second end 106 along the centerline of cord 102. In suitable embodiments, the length of cord 102 may be any measurement that enables animal collar 100 to function as described herein. Suitably, the length is in the range between about 8 inches and about 50 inches. In the illustrated embodiment, for example, the length of the cord 102 is approximately 24 inches. In other embodiments, cord 102 may have a length less than 8 inches or greater than 50 inches. In the exemplary embodiment, cord 102 is fabricated from an elastic material including, but not limited to, at least one of shock cord (also known as “bungee” cord) and paracord. In alternative embodiments, cord 102 is fabricated from non-elastic material. In other suitable embodiments, cord 102 is fabricated from any material that facilitates animal collar 100 functioning as described herein. Further, in some embodiments, cord 102 includes an optically-reflective element, such as a retroreflective element, or a phosphorescent element to enhance the visibility of collar 100 in low lighting.

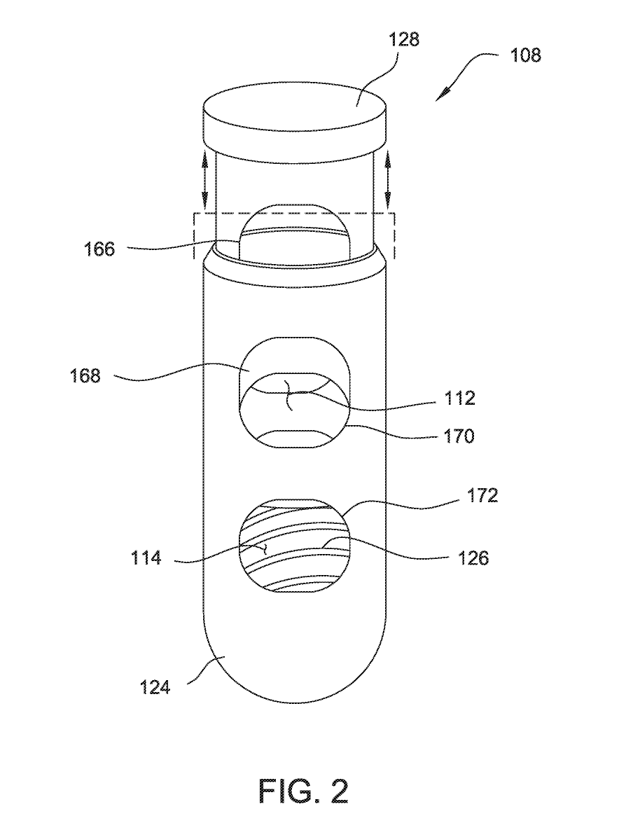

FIG. 2 is a perspective view of first clamp 108 shown in the form of a double-barrel cord lock. In the exemplary embodiment, first clamp 108 and second clamp 110 have identical configurations, and operate in the same manner. Alternatively, first clamp 108 and second clamp 110 are any other cord retention devices, including, without limitation, friction cord-retention devices, cam driven cord-retention devices, and/or any combination thereof. In the exemplary embodiment, each of first clamp 108 and second clamp 110 includes an outer housing 124 that at least partially defines a first passage 112 and a second passage 114. First passage 112 and second passage 114 extend from a pair of respective first openings 170, 172 on a first side of outer housing 124 to respective second openings (not labeled in FIG. 2) on a diametrically opposite side of outer housing 124. Each of first passage 112 and second passage 114 is configured (i.e., sized and shaped) to receive cord 102. As shown in FIG. 1, cord 102 extends from first end 104, through first and second passages 112 and 114 in each of first and second clamps 108 and 110, and to second end 106 to define a closed loop 116. In the exemplary embodiment, cord 102 extends in series, from first end 104, through first passage 112 of first clamp 108, through first passage 112 of second clamp 110, through second passage 110 of first clamp 108 and through second passage 114 of second clamp 110 to second end 106 to define closed loop 116.

Outer housing 124 also defines a cavity sized and shaped to slidably receive a depressible member 128 therein. Depressible member 128 is disposed for reciprocal movement within outer housing 124. Specifically, depressible member 128 is movable within the cavity between a first, depressed position, indicated with broken lines in FIG. 2, and a second, extended or undepressed position, shown in FIG. 2. Depressible member 128 includes a first opening 166 and a second opening 168, each of which is configured (i.e., sized, shaped) to receive cord 102. A spring 126 is disposed within outer housing 124, and engages depressible member 128 to bias depressible member 128 towards the undepressed position. When depressible member is in the first, depressed position, depressible member first opening 166 is substantially aligned with respective first opening 170 and second opening of outer housing 124 to form first passage 112, and depressible member second opening 168 is substantially aligned with respective first opening 172 and second opening of outer housing 124 to form a second passage 114.

First clamp 108 and second clamp 110 are adjustably coupled to cord 102 such that a size of loop 116 is selectively adjustable. When depressible member 128 is in the first, undepressed position, the corresponding first or second clamp 108 or 110 exerts a clamping force on cord 102 to restrict or inhibit movement of cord 102 through first and second passages 112 and 114. When depressible member 128 is moved to the depressed position, the corresponding first clamp 108 or second clamp 110 is freely slidable along cord 102 such that a size of closed loop 116 is selectively adjustable.

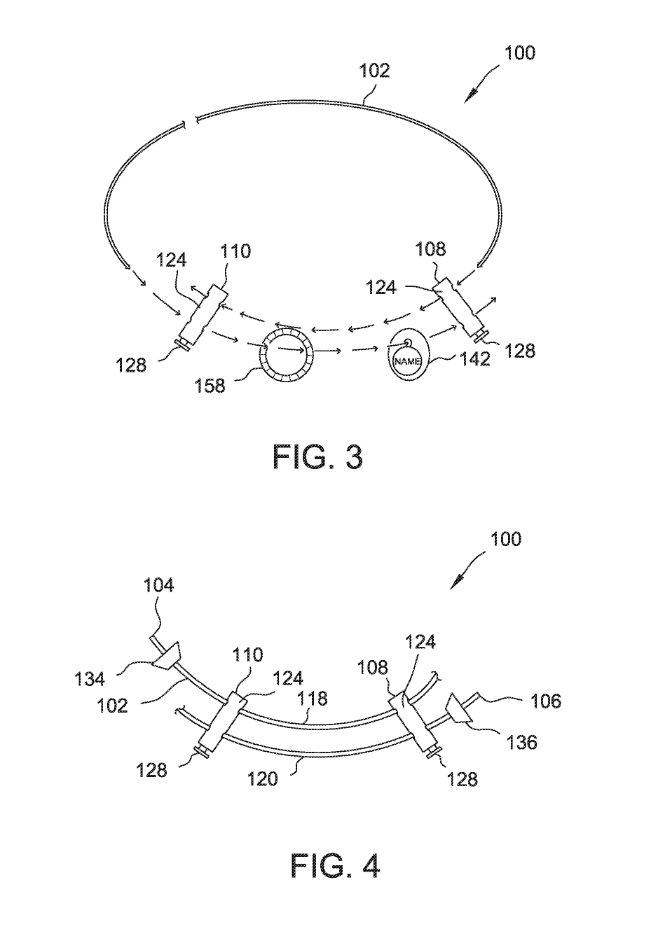

FIG. 3 is a perspective view of animal collar 100 illustrating an exemplary method of assembling animal collar 100. More specifically, in the exemplary embodiment, animal collar 100 is configured to be assembled from single continuous cord 102 and to be adjustable to fit a variety of animals using first clamp 108 and second clamp 110.

In the exemplary method of assembly, depressible member 128 of first clamp 108 is depressed to the second position and first end 104 of cord 102 is inserted through second passage 114 of clamp 108. With depressible member 128 of first clamp 108 in the second position and depressible member 128 of second clamp 110 in the second position, cord 102 is drawn through second passage 114 of first clamp 108, and first end 104 is inserted into and drawn through second passage 114 of second clamp 110 to form a first overlapping segment 118, shown in FIG. 4. While depressible member 128 of second clamp 110 is in the second position, second end 106 of cord 102 is inserted through first passage 112 of second clamp 110. With depressible member 128 of second clamp 110 in the depressed position and depressible member 128 of first clamp 108 in the depressed position, cord 102 is drawn through first passage 112 of second clamp 110, and first end 104 is inserted into and drawn through first passage 112 of first clamp 108 to form a second overlapping segment 120, shown in FIG. 4.

In the exemplary embodiment, identification tag 142 and attachment device 158 are coupled to second overlapping segment 120 by inserting cord 102 through an opening in each of identification tag 142 and attachment device 158 after cord 102 is inserted through first passage 112 of second clamp 110 and before cord 102 is inserted through first passage 112 of first clamp 108. In other embodiments, one or both of identification tag 142 and attachment device 158 are coupled to first overlapping segment 118. Identification tag 142 generally includes identifying indicia used to identify an animal wearing collar 100. Suitable identifying indicia includes, for example and without limitation, an animal name, an owner name, a serial number, and combinations thereof. In some embodiments, identification tag 142 is a disposable tag including a writing surface for making markings thereon, such as identifying indicia. The term “disposable tag” refers to tags that are intended to be used with a single animal for a limited duration, such as less than 7 days, less than 5 days, less than 3 days, or even less than 1 day, and discarded after use. Exemplary disposable tags include, for example and without limitation, paper tags and Tyvek® tags. In other embodiments, identification tag 142 includes a writable-erasable surface to facilitate reuse of collar 100. Further, in some embodiments, the tag 142 includes an opening therein for receiving a portion of attachment device 158 to couple tag 142 to cord 102. Attachment device 158 includes, for example and without limitation, a key ring, a lobster clasp, and any other suitable fastener capable of coupling identification tag 142 to cord 102 to facilitate attachment of tags to collar 100. FIG. 7 is a partial perspective view of collar 100 with identification tag 142 coupled to cord 102 via attachment device 158.

FIG. 4 is partial perspective view of animal collar 100 illustrating first and second concealing members 134 and 136 being coupled to cord 102. Identification tag 142 and attachment device 158 are omitted in FIG. 4 for illustrative purposes. Each of first and second concealing members 134 and 136 defines an opening or aperture sized and shaped to receive cord 102. Cord 102 is inserted through the opening in concealing members 134 and 136 to couple concealing members 134 and 136 to cord 102. In this embodiment, cord first end 104 is inserted through first concealing member 134, and cord second end 106 is inserted through second concealing member 136. First and second concealing members 134 and 136 are configured to conceal or occlude the ends of cord 102 to enhance the aesthetic appearance of collar 100. In some embodiments, first and second concealing members 134 and 136 are omitted from collar 100.

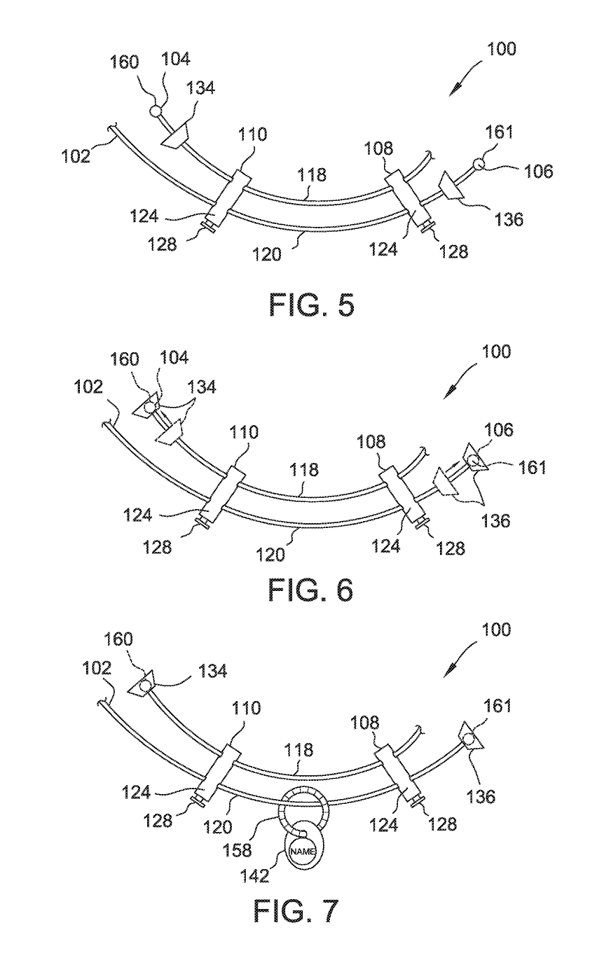

FIG. 5 is a partial perspective view of animal collar 100 illustrating a first end stop 160 and a second end stop 161. Identification tag 142 and attachment device 158 are omitted in FIG. 5 for illustrative purposes. In the exemplary embodiment, collar 100 includes first stop 160 disposed at cord first end 104, and second stop 162 disposed at cord second end 106. First stop 160 is configured to inhibit cord first end 104 from passing through first and second passages 112 and 114 defined by first and second clamps 108 and 110. Second stop 162 is configured to inhibit cord second end 106 from passing through first and second passages 112 and 114 defined in first and second clamps 108 and 110. First end stop 160 and second end stop 161 thus facilitate preventing disassembly of animal collar 100 by preventing a respective one of first end 104 and second end 106 from being withdrawn through a respective one of first clamp 108 and second clamp 110.

Following coupling of first concealing member 134 and second concealing member 136 to cord 102, first end stop 160 is fabricated at first end 104 and second end stop 161 is fabricated at second end 106. For example, but not by way of limitation, each of first end stop 160 and second end stop 161 is a cauterized knot sized and shaped to be received within each of first concealing member 134 and second concealing member 136. In other embodiments, first and second stops 160 and 161 are formed from knots with an adhesive, sealant, or some other coating applied to prevent the knot from unraveling. First concealing member 134 and second concealing member 136 are configured to receive a respective one of first end stop 160 and second end stop 161 and to conceal the respective first end stop 160 and second end stop 161.

FIG. 6 is a partial perspective view of animal collar 100 illustrating coupling first concealing member 134 to first end stop 160 and second concealing member 136 to second end stop 161. Identification tag 142 and attachment device 158 are omitted in FIG. 6 for illustrative purposes In the exemplary embodiment, each of first and second stops 160 and 162 includes a respective concealing member 134 and 136 coupled to cord 102 and configured to conceal at least a portion of corresponding first stop 160 or second stop 162.

With reference to FIGS. 1-6, in some embodiments, a size or diameter of closed loop 116 formed by cord 102 can be adjusted by depressing depressible member 128 of each of first clamp 108 and second clamp 110, and moving each of first clamp 108 and second clamp 110 along the perimeter of closed loop 116. When collar 100 is tightened, decreasing the diameter of closed loop 116, first clamp 108 and second clamp 110 are moved in opposite directions along the perimeter of closed loop 116, increasing the distance or length of cord 102 between first clamp 108 and second clamp 110. Stops 160 and 161 are configured to interact with a respective one of first clamp 108 and second clamp 110 to facilitate preventing slack cord by lengthening each of first overlapping segment 118 and second overlapping segment 120 as each of first clamp 108 and second clamp 110 are moved in opposite directions along the perimeter of closed loop 116. When collar 100 is loosened, cord 102 is pulled through a respective one of first clamp 108 and second clamp 110, decreasing the distance or length of cord 102 between first clamp 108 and second clamp 110 as the two clamps are moved towards each other along the perimeter of closed loop 116.

Moreover, with reference to FIGS. 1-6, in some embodiments, animal collar 100 may be placed on or removed from the animal by stretching cord 102, facilitating rapid placement and removal of animal collar 100 and facilitating improved levels of safety for the animal in the event animal collar 100 becomes entangled while in use on the animal.

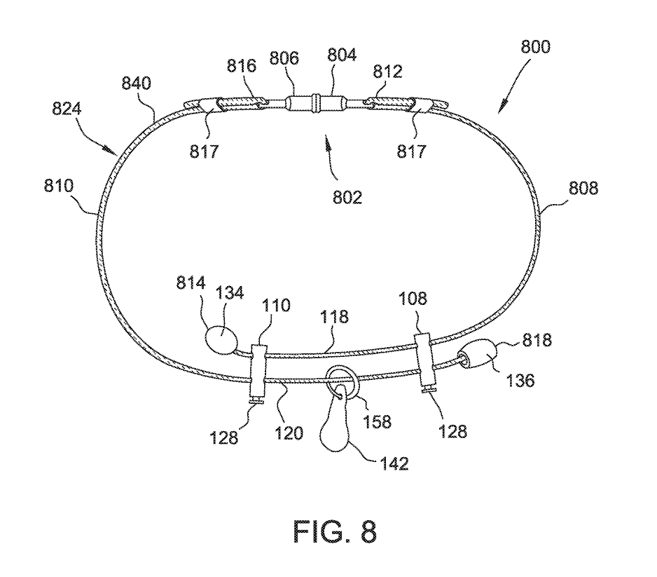

FIG. 8 is a perspective view of an exemplary animal collar 800 that includes a first cord 808, a second cord 810, and a quick-release assembly 802 coupled to first and second cords 808 and 810. In the exemplary embodiment, animal collar 800 is a dog collar. In alternative embodiments, animal collar is configured for use as any type of animal collar that facilitates operation of animal collar 800 as described herein. Additionally, in this embodiment, animal collar 800 includes first clamp 108, second clamp 110, first concealing member 134, second concealing member 136, and attachment device 158. First clamp 108 and second clamp 110 are each adjustably coupled to first cord 808 and second cord 810.

As illustrated in FIG. 8, first cord 808 includes a first end 812 and a second end 814, and second cord 810 includes a first end 816 and a second end 818. First cord 808 extends a distance or length of cord 808 between first end 812 and second end 814. Second cord 810 extends a distance or length of cord 810 between first end 816 and second end 818. In suitable embodiments, first and second cords 808 and 810 may have any suitable length that allows animal collar 800 to function as described herein. Suitably, each of first cord 808 and second cord 810 has a length in the range between about 4 inches and about 25 inches. In the exemplary embodiment, for example, first cord 808 and second cord 810 each have a length of approximately 12 inches. In other embodiments, first cord 808 and/or second cord 810 may have a length less than 4 inches or greater than 25 inches.

In the exemplary embodiment, each of first cord 808 and second cord 810 is fabricated from an elastic material including an optically-reflective element 840, such as a retroreflective element. In alternative embodiments, each of first cord 808 and second cord 810 are fabricated from non-elastic material. In other suitable embodiments, each of first cord 808 and second cord 810 are fabricated from any material that facilitates animal collar 800 functioning as described herein.

In the exemplary embodiment, with reference to FIGS. 2 and 8, first cord 808 passes through second passage 114 of first clamp 108 and second passage 114 of second clamp 110 and is coupled at first cord second end 814 to first concealing member 134. Second cord 810 passes through first passage 112 of second clamp 110 and first passage 112 of first clamp 108 and is coupled at second cord second end 818 to second concealing member 136. First overlapping segment 118 is defined as the portion of first cord 808 between first clamp 108 and second clamp 110. Second overlapping segment 120 is defined as the portion of second cord 810 between first clamp 108 and second clamp 110. In the exemplary embodiment, attachment device 158 is coupled to second overlapping segment 120. In other suitable embodiments, identification tag 142 is coupled directly to second overlapping segment 120. In alternative embodiments, attachment device 158 and identification tag 142 are included in any combination and coupled to any portion of animal collar 800 that facilitates animal collar 800 functioning as described herein.

In the exemplary embodiment, quick-release assembly 802 includes a first coupler 804 and a second coupler 806. First coupler 804 cooperatively engages second coupler 806 such that first and second couplers 804 and 806 are releasably coupleable to one another to form a closed loop 824. In the exemplary embodiment, each of first coupler 804 and second coupler 806 is a magnetic coupler configured to magnetically interface with each other to form closed loop 824 of animal collar 800 while being worn by an animal. Couplers 804 and 806 are thus coupleable and decoupleable to facilitate application and removal of animal collar 800 from the wearing animal. In alternative embodiments, first coupler 804 and second coupler 806 are any suitable type of connectors that allows animal collar 800 to function as described herein.

First coupler 804 and second coupler 806 are configured to receive a respective one of first cord first end 812 and second cord first end 816. In the exemplary embodiment, each of first cord first end 812 and second cord first end 816 are coupled to a respective one of first coupler 804 and second coupler 806 by threading a respective one of first cord first end 812 and second cord first end 816 through an opening of a respective one of first coupler 804 and second coupler 806 and fixing first cord first end 812 and second cord first end 816 to the respective first cord 808 or second cord 810 using, for example, a non-adjustable clamp 817. In alternative embodiments, each of first cord first end 812 and second cord first end 816 is coupled to a respective one of first coupler 804 and second coupler 806 in any way that facilitates animal collar 800 operating as described herein.

First and second couplers 804 and 806 are configured such that they react to primarily tensile forces, i.e. forces that tend to separate first cord 808 from second cord 810 at the interface between couplers 804 and 806. Additionally, couplers 804 and 806 are configured to facilitate decoupling when the tensile force acting on each of first cord 808 and second cord 810 exceeds a threshold force. For example, first coupler 804 and second coupler 806 react to tensile forces exerted upon first cord 808 and second cord 810 while animal collar 800 is being worn by an animal until a tensile force threshold is met, at which point first coupler 804 and second coupler 806 decouple. Quick release assembly 802 thereby facilitates rapid removal of animal collar 800 by a handler for collar transfer, and also facilitates the release of animal collar 800 from an animal's neck if animal collar 800 becomes entangled with a foreign object.

In some embodiments, the size or diameter of closed loop 824 formed by first cord 808 and second cord 810 can be adjusted by depressing depressible member 128 of each of first clamp 108 and second clamp 110 and moving each of first clamp 108 and second clamp 110 along the perimeter of closed loop 824. When collar 800 is tightened, decreasing the diameter of closed loop 824, each of first clamp 108 and second clamp 110 are moved in directions opposite of each other along the perimeter of closed loop 824, increasing the distance between first clamp 108 and second clamp 110. Cord stops, such as stops 160 and 161 (FIG. 5) are configured to interact with a respective one of first clamp 108 and second clamp 110 to facilitate preventing slack cord by lengthening each of first overlapping segment 118 and second overlapping segment 120 as each of first clamp 108 and second clamp 110 are moved in direction opposite each other along the perimeter of closed loop 824. When collar 800 is loosened, cord 102 is pulled through a respective one of first clamp 108 and second clamp 110, decreasing the distance between first clamp 108 and second clamp 110 as the two clamps are moved towards each other along the perimeter of closed loop 824. Preventing the creation of slack line facilitates improving safety for the animal as there is less of the collar to become entangled or to be caught by other animals.

Moreover, with reference to FIG. 8, in some embodiments, animal collar 800 may be placed on an animal by decoupling couplers 804 and 806, situating animal collar 800 on the animal's neck, and coupling couplers 804 and 806 together. Removal of animal collar 800 can be accomplished by decoupling couplers 804 and 806 from one another. Additionally, couplers 804 and 806 are configured to decouple once a threshold level of tensile force is exceeded, facilitating improved levels of safety for the animal in the event animal collar 800 becomes entangled while in use on the animal.

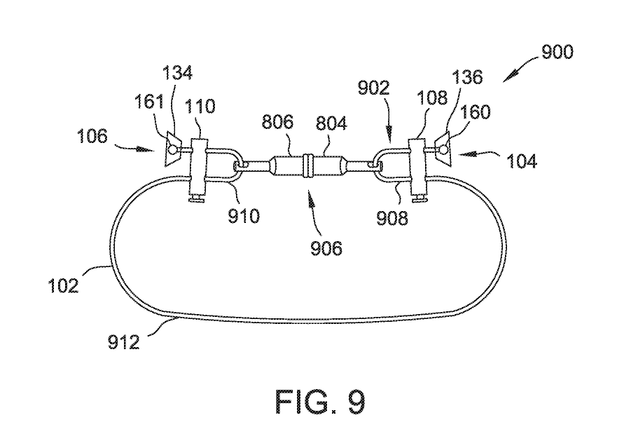

FIG. 9 is a perspective view of another embodiment of an animal collar 900. Animal collar 900 includes components of animal collar 100 and animal collar 800 arranged in a different configuration. Specifically, in the exemplary embodiment, animal collar 900 includes cord 102, first clamp 108, second clamp 110, first stop 160, second stop 161, and a quick-release assembly 906.

With reference to FIGS. 2 and 9, in this embodiment, cord 102 extends in series from first end 104, through first passage 112 of first clamp 108, back through second passage 114 of first clamp 108, through second passage 114 of second clamp 110, back through first passage 114 of second clamp 110, to second end 106, forming a closed loop 912. First stop 160 is disposed at first end 104 of cord 102, and is configured to prevent first end 104 from passing through first passage 112 of first clamp 108. Second stop 161 is disposed at second end 106 of cord 102, and is configured to inhibit second end 106 of cord 102 from passing through first passage 114 of second clamp 110. In this embodiment, a first segment 908 of cord 102 extends from first passage 112 of first clamp 108 to second passage 114 of first clamp 108 to define a second loop 902. Further, in this embodiment, a second segment 910 of cord 102 extends from first passage 112 of second clamp 110 to second passage 114 of second clamp 110 to define a third loop 904. In alternative embodiments, cord 102 extends through each of first clamp 108 and second clamp 110 in any arrangement as facilitates animal collar 900 functioning as described herein.

Quick release assembly 906 is identical to quick release assembly 802 described above with reference to FIG. 8. For example, quick release assembly 906 includes first coupler 804 and second coupler 806. In the exemplary embodiment, first coupler 804 and second coupler 806 are slidably coupled to cord 102. Specifically, first coupler 804 is slidably coupled to second loop 902 of cord 102, and second coupler 806 is slidably coupled to third loop 904 of cord 102. In alternative embodiments, each of first coupler 804 and second coupler 806 are coupled to any portion of cord 102 that enables animal collar 900 to function as described herein.

With reference to FIG. 9, first and second couplers 804 and 806 are configured such that they react to primarily tensile forces, i.e. forces that tend to separate first segment 908 from second segment 910 at the interface between couplers 804 and 806. Additionally, couplers 804 and 806 are configured to facilitate decoupling when the tensile force acting on each of first segment 908 and second segment 910 exceeds a threshold force. For example, first coupler 804 and second coupler 806 react to tensile forces exerted upon first segment 908 and second segment 910 while animal collar 900 is being worn by an animal until a tensile force threshold is met, at which point first coupler 804 and second coupler 806 decouple. Quick release assembly 906 thereby facilitates rapid removal of animal collar 900 by a handler for collar transfer, and also facilitates the release of animal collar 900 from an animal's neck if animal collar 900 becomes entangled with a foreign object.

With reference to FIG. 9, in some embodiments, the diameter of closed loop 912 formed by cord 102 can be adjusted by depressing depressible member 128 (FIG. 2) of each of first clamp 108 and second clamp 110 and moving each of first clamp 108 and second clamp 110 along the perimeter of closed loop 912. When collar 900 is tightened, decreasing the diameter of closed loop 912, each of first clamp 108 and second clamp 110 are moved in directions opposite of each other along the perimeter of closed loop 912, increasing the distance between first clamp 108 and second clamp 110. Cord stops 160 and 161 are configured to interact with a respective one of first clamp 108 and second clamp 110 to facilitate preventing slack cord by increasing the perimeter of each of second loop 902 and third loop 904 as each of first clamp 108 and second clamp 110 are moved in opposite directions along the perimeter of closed loop 912. When collar 900 is loosened, cord 102 is pulled through a respective one of first clamp 108 and second clamp 110, decreasing the distance between first clamp 108 and second clamp 110 as the two clamps are moved towards each other along the perimeter of closed loop 912. Preventing the creation of slack line facilitates improving safety for the animal as there is less of the collar to become entangled or caught by other animals and/or foreign objects.

Moreover, with reference to FIG. 9, in some embodiments, animal collar 900 may be placed on the animal by decoupling couplers 804 and 806, situating animal collar 900 on the animal's neck, and coupling couplers 804 and 806 together. Removal of animal collar 900 can be accomplished by decoupling couplers 804 and 806 from one another. Additionally, couplers 804 and 806 are configured to decouple once a threshold level of tensile force is exceeded, facilitating improved levels of safety for the animal in the event animal collar 900 becomes entangled while in use on the animal.

The above-described embodiments relate to animal collars including adjustable features and rapid removal features. Embodiments of dog collars described herein include double adjustment clamps that facilitate quickly and easily adjusting the inner diameter of the main collar loop while reducing or eliminating any slack generated by resizing the main loop. Additionally, rapid removal features of animal collars described herein facilitate the collar being quickly placed on and removed from an animal, including removal when the collar becomes entangled or caught on an object. The embodiments provide advantages over at least some known collars with adjustment features and rapid removal features. Specifically, in some embodiments, the animal collar includes a collar with a single continuous elastic cord including two adjustment clamps that facilitate configuring the collar to fit multiple animals without leaving loose-hanging portions of the collar. Additionally or alternatively, the flexible cord is further configured to facilitate slipping the collar over the animals head and to facilitate the collar releasing from the animal if it becomes entangled. As such, ease of fitting the collar and safety of the wearing animal are improved.

Also specifically, in certain embodiments, the animal collar includes magnetic couplers and two elastic cords including two adjustment clamps that facilitate sizing the collar to fit multiple animals without leaving loose-hanging portions of the collar.

Although specific features of various embodiments of the technology may be shown in some drawings and not in others, this is for convenience only. In accordance with the principles of the invention, any feature of a drawing may be referenced or claimed in combination with any feature of any other drawing.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An animal collar comprising:
an elastic cord having a first end and a second end;
a first clamp coupled to said cord; and
a second clamp coupled to said cord, each of said first and second clamps defining a first passage and a second passage;
wherein said cord extends from said first end, through the first and second passages in each of said first and second clamps, and to said second end to define a closed loop;
wherein said first clamp and said second clamp are adjustably coupled to said cord such that a size of said loop is selectively adjustable.

2. The animal collar according to claim 1, wherein each of said first clamp and said second clamp comprises a cord lock comprising a depressible member moveable between a first, undepressed position and a second, depressed position, wherein said cord lock exerts a clamping force on said cord when said depressible member is in the first position, and wherein said cord lock is freely slidable along said cord when said depressible member is moved to the depressed position.

3. The animal collar according to claim 2, wherein said cord lock comprises an outer housing at least partially defining the first and second passages, said depressible member disposed within said outer housing for reciprocal movement therein.

4. The animal collar according to claim 2, wherein said cord lock further comprises a spring that biases said depressible member toward the undepressed position.

5. The animal collar according to claim 1, wherein said cord extends, in series, from said first end, through the first passage of said first clamp, through the first passage of said second clamp, through the second passage of said first clamp and through the second passage of said second clamp to said second end to define said closed loop.

6. The animal collar according to claim 1, wherein said cord comprises a first stop disposed at said first end, and a second stop disposed at said second end, wherein said first stop is configured to inhibit said first end from passing through the first and second passages defined in said first and second clamps, and said second stop is configured to inhibit said second end from passing through the first and second passages defined in said first and second clamps.

7. The animal collar according to claim 6, wherein each of said first and second stops comprises a cauterized knot.

8. The animal collar according to claim 6, wherein each of said first and second stops comprises a concealing member coupled to said cord and configured to conceal at least a portion of the corresponding first or second stop.

9. The animal collar according to claim 1, wherein said cord comprises an optically-reflective element.

10. The animal collar according to claim 1, wherein said cord includes first and second overlapping segments extending between said first and second clamps, said cord further including a third segment extending from said first clamp to said second clamp and not overlapping either of said first and second overlapping segments.

11. The animal collar according to claim 10 further comprising an identification tag coupled to said cord along one of said first and second overlapping segments between said first and second clamps.

12. The animal collar according to claim 1, wherein said cord comprises shock cord.

13. The animal collar according to claim 1, further comprising a quick-release assembly coupled to said cord and comprising:
a first coupler coupled to a first segment of said cord; and
a second coupler coupled to a second segment of said cord, wherein said first coupler is releasably coupleable to said second coupler to form said closed loop.

14. The animal collar according to claim 13, wherein said first segment extends from the first passage of said first clamp to the second passage of said first clamp to define a second loop, and said second segment extends from the first passage of said second clamp to the second passage of said second clamp to define a third loop, wherein said first coupler is coupled to said second loop, and said second coupler is coupled to said third loop.

15. An animal collar comprising:
at least one cord having a first end and a second end;
a first clamp coupled to said at least one cord; and
a second clamp coupled to said at least one cord, each of said first and second clamps defining a first passage and a second passage;
wherein said at least one cord extends from said first end, through the first and second passages in each of said first and second clamps, and to said second end to define a closed loop;
wherein said first clamp and said second clamp are adjustably coupled to said at least one cord such that a size of said loop is selectively adjustable.

16. The animal collar according to claim 15, wherein each of said first clamp and said second clamp comprises a cord lock comprising a depressible member moveable between a first, undepressed position and a second, depressed position, wherein said cord lock exerts a clamping force on said at least one cord when said depressible member is in the first position, and wherein said cord lock is freely slidable along said at least one cord when said depressible member is moved to the depressed position.

17. The animal collar according to claim 15, wherein said at least one cord includes first and second overlapping segments extending between said first and second clamps, said animal collar further comprising an identification tag coupled to said at least one cord along one of said first and second overlapping segments between said first and second clamps.

18. The animal collar according to claim 15, wherein said at least one cord comprises a first stop disposed at said first end, and a second stop disposed at said second end, wherein said first stop is configured to inhibit said first end from passing through the first and second passages defined in said first and second clamps, and said second stop is configured to inhibit said second end from passing through the first and second passages defined in said first and second clamps.

19. The animal collar according to claim 15, wherein said at least one cord comprises a single cord defining said first end and said second end.

20. The animal collar according to claim 19, wherein said cord comprises an elastic cord.

21. The animal collar according to claim 19, wherein said cord extends, in series, from said first end, through the first passage of said first clamp, through the first passage of said second clamp, through the second passage of said first clamp, and through the second passage of said second clamp to said second end to define said closed loop.

22. The animal collar according to claim 15, wherein said at least one cord comprises:
a first cord having a first end and a second end; and
a second cord having a first end and a second end, wherein said first end of said first cord defines said first end of said at least one cord, and said first end of said second cord defines said second end of said at least one cord.

23. The animal collar according to claim 22, further comprising a quick-release assembly coupled to said at least one cord, said quick-release assembly comprising:
a first coupler coupled to said second end of said first cord; and
a second coupler coupled to said second end of said second cord, said first coupler releasably coupleable to said second coupler to form said closed loop with said first and second cords.

24. The animal collar according to claim 23, wherein said first coupler comprises a first magnet, and said second coupler comprises a second magnet magnetically coupleable to said first magnet.

25. An animal neck collar comprising:
a first cord;
a second cord;
a first clamp coupled to said first cord and said second cord;
a second clamp coupled to said first cord and said second cord, each of said first and second clamps defining a first passage and a second passage, wherein said first cord extends from a first end through the first passage in each of said first and second clamps to a second end, and said second cord extends from a first end through the second passage in each of said first and second clamps to a second end; and
a quick-release assembly comprising:
a first coupler coupled to said second end of said first cord; and
a second coupler coupled to said second end of said second cord, said first coupler releasably coupleable to said second coupler to define a closed loop with said first and second cords;
wherein said first clamp and said second clamp are adjustably coupled to said first and second cords such that a size of said loop is selectively adjustable.

26. The animal collar according to claim 25, wherein each of said first clamp and said second clamp comprises a cord lock comprising a depressible member moveable between a first, undepressed position and a second, depressed position, wherein said cord lock exerts a clamping force on said first and second cords when said depressible member is in the first position, and wherein said cord lock is freely slidable along said first and second cords when said depressible member is moved to the depressed position.

27. The animal collar according to claim 25, further comprising:
a first stop disposed at said first end of said first cord, said first stop configured to inhibit said first end of said first cord from passing through the first passages defined in said first and second clamps; and
a second stop disposed at said first end of said second cord, said second stop configured to inhibit said first end of said second cord from passing through the second passages defined in said first and second clamps.

28. The animal collar according to claim 25, wherein said first coupler comprises a first magnet, and said second coupler comprises a second magnet magnetically coupleable to said first magnet.
